(19) United States
(12) Patent Application Publication
(10) Pub. No.: US 2024/0418572 A1
(43) Pub. Date: Dec. 19, 2024

(54) BROADBAND CAMERA FOR INSPECTION OF HIGH-TEMPERATURE PROCESSING ENVIRONMENT

(71) Applicant: LightPath Technologies, Inc., Orlando, FL (US)

(72) Inventor: Shmuel RUBIN, Winter Park, FL (US)

(73) Assignee: LightPath Technologies, Inc., Orlando, FL (US)

(21) Appl. No.: 18/741,788

(22) Filed: Jun. 13, 2024

Related U.S. Application Data
(60) Provisional application No. 63/521,233, filed on Jun. 15, 2023.

(51) Int. Cl. G01J 5/08; G01J 5/00; G01J 5/02; G01J 5/0806

(52) U.S. Cl. CPC G01J 5/0879; G01J 5/0044; G01J 5/026; G01J 5/0806; G01J 5/084

(57) ABSTRACT

An inspection system for inspecting an interior of high temperature process equipment includes an infrared camera; a first wedge prism and a second wedge prism to be inserted into a port of the high temperature process equipment to view the interior; and an optical relay and relaying light output from the first and second wedge prisms to the infrared camera.

### CROSS-REFERENCE TO RELATED APPLICATION

The present application claims priority to Provisional Ser. No. 63/521,233 filed on Jun. 15, 2023, the entire contents of which are incorporated herein by reference.

### BACKGROUND

### Field

The present disclosure relates to imaging in using a broadband camera to inspect a furnace or other high-temperature industrial processing environments.

### Description of the Related Art

Thermal cameras are today routinely used for inspection interiors of processing equipment, e.g., furnaces, boilers, ovens and more, during their operation. In the case of high temperature furnaces, a camera with its electronics cannot be exposed directly to the high temperatures. To solve this, a long metal tube with a relay optical system inside the tube is used to relay the image from inside the furnace, to the camera on the other side of the relay This pipe with the relay optics is then inserted into the furnace through a hole or port in the wall of the furnace. The pipe is typically cooled with either an internal air flow or water cooling.

However, since high temperature furnaces have thick walls (4′ to 12′ is commonly seen), and one does not want to open a very large hole for the relay optics pipe, users end up having a pipe that can be inserted into the furnace through that hole or port but cannot point or tilt at any angle to see any specific place. To resolve this lack of pointing capability, the system is designed with a very large field of view, in order to image as much as possible of the inside of the furnace. This in turn reduces the effective resolution or size of items that can be resolved, limiting the amount of effective information the user receives.

### SUMMARY

One or more embodiments is directed to an infrared imaging system, more particularly to an inspection system for inspecting an interior of high temperature process equipment includes an infrared camera; a first wedge prism and a second wedge prism to be inserted into a port of the high temperature process equipment to view the interior; and an optical relay and relaying light output from the first and second wedge prisms to the infrared camera.

### BRIEF DESCRIPTION OF THE DRAWINGS

FIG. 1 illustrates a schematic side view of an optical relay.

FIG. 2 illustrates a schematic side view of a pair of wedge prisms with an optical relay.

FIG. 3 is a schematic perspective view of a system for inspection of a high-temperature-processing environment, with a pair of wedge prisms.

FIGS. 4 and 5 illustrate configurations using multiple wedge prisms.

FIG. 6 illustrates the wedge prisms at a home position.

FIG. 7 illustrates a housing and control for separately rotating the wedge prisms in the Risley prism.

FIG. 8A illustrates a perspective view of a metal tube with a mechanical control mechanism.

FIG. 8B illustrates a cross-sectional side view of a final section of the metal tube with the mechanical control mechanism.

FIG. 8C illustrates a perspective detailed view of the final section of the metal tube with the mechanical control mechanism.

FIGS. 9A and 9B are representative scan patterns that can be realized by rotating the wedge prisms.

The scope of the present disclosure is best understood from the following detailed description of exemplary embodiments when read in conjunction with the accompanying drawings.

### DETAILED DESCRIPTION

By being able to move the field of view within an interior of processing equipment having a high temperature processing environment, the size of the field of view can be reduced, allowing more detail to be captured, while allowing images from different areas within the field of regard to be captured. One or more embodiments is directed to controlling the field of view using a Risley prism scanner at the very end of the relay optics, i.e., near an area of interest to be imaged. A Risely prism scanner uses two or more wedge prisms to steer the field of view. In particular, by rotating the wedge prisms relative to one another, the field of view can be pointed to the area of interest, providing a high effective resolution.

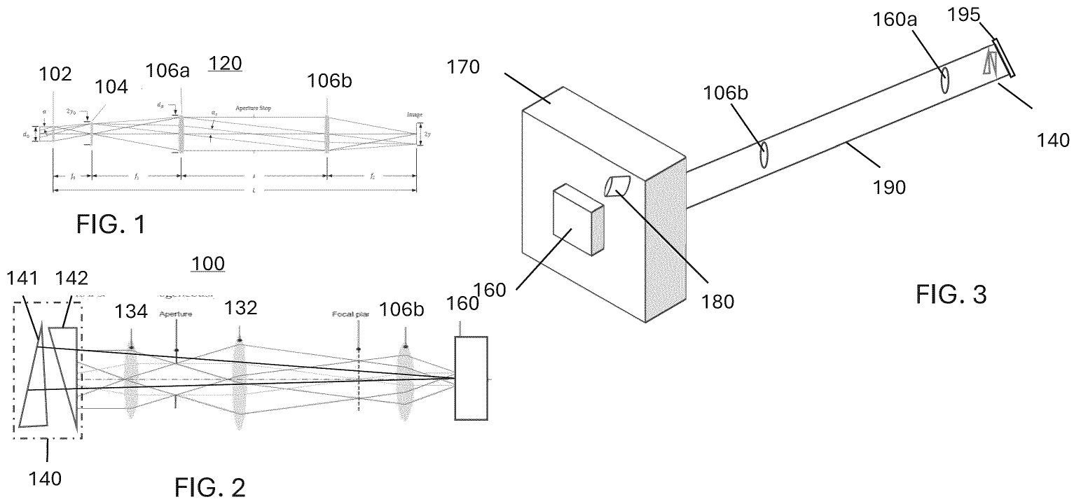

As shown in FIGS. 1 and 2, a camera inspection system 100 may include an optical relay 120, a pair of wedge prisms 140 at a first end of the optical relay 120, and a thermal camera 160 at a second end of the optical relay 120. The optical relay 120 may include an objective lens 102, a collector lens 104, and at least two relay lenses 106a, 106b, each pair of adjacent relay lenses including an intermediate plane of focus, i.e., an aperture stop 108, therebetween. The pair of wedge prisms 140, i.e. a first wedge prism 141 and a second wedge prism form a Risley prism scanner. The pair of wedge prisms 140 is a final optical element for imaging the interior of the high temperature processing environment. In some cases, a protective optical window 195 will be placed in front of the wedges, to shield them from ashes and other dirt from the furnace, but does not otherwise affect the image itself.

The camera inspection system 100 may also include a focus lens 132 and a collimator 134 between the optical relay 120, i.e., a final relay lens 106b of the optical relay 120, and the pair of wedge prisms 140. Light incident on the Risley prism 140 is output to the camera 160. A suitable cameras for use as the camera 160 includes a broadband uncooled microbolometer manufactured by LightPath® Technologies, although any infrared camera for use in the wavelengths to be monitored, typically middle wavelength infrared (MWIR) wavelengths can be used. The specific wavelength region of interest will depend on the process being monitored and the camera inspection system may include wavelength filters based on the process being monitored.

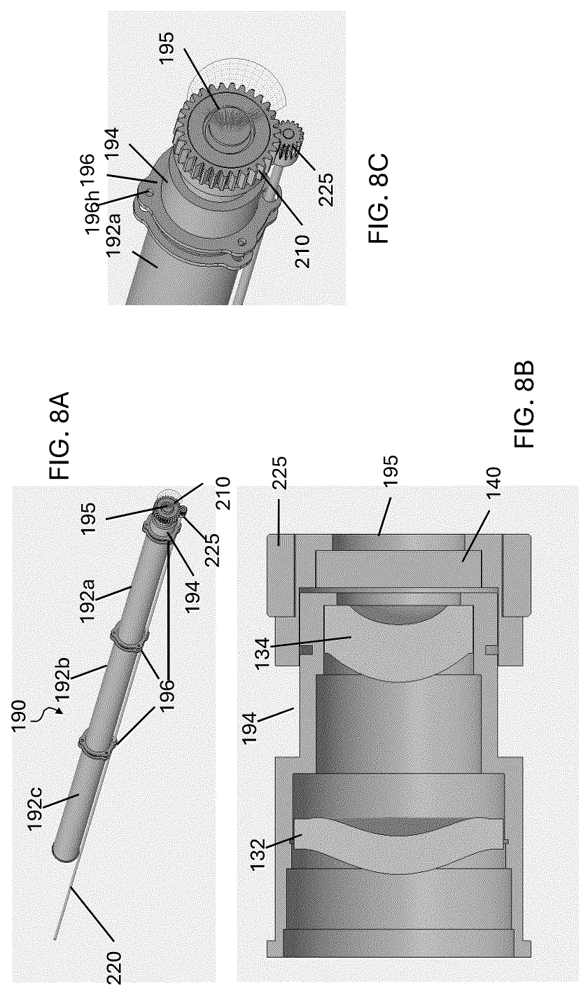

FIG. 3 illustrates the system 100 shown with housing components. The housing includes a metal tube 190 housing the wedge prisms 141, 142 and the optical relay 120. A heat shield 170 on which the camera 160 may be mounted further protects the camera 160. A control button 180 may be provided on the heat shield to allow manual rotation of the wedge prisms 141, 142. Alternatively, the wedge prisms can be rotated using a mechanical relay shaft (shown in FIGS. 8A to 8C, discussed below) that allows the camera operator to rotate each prism separately, or all together, to point the camera to the direction the operator wishes to image. The metal tube 190 may be secured to the heat shield 170 at a first end, with a second end thereof to be inserted into the processing environment. The second end of the metal tube 190 may include an optical protective window 195 to protect the optical elements inside the metal tube 190 from being contaminated by the interior of the processing environment.

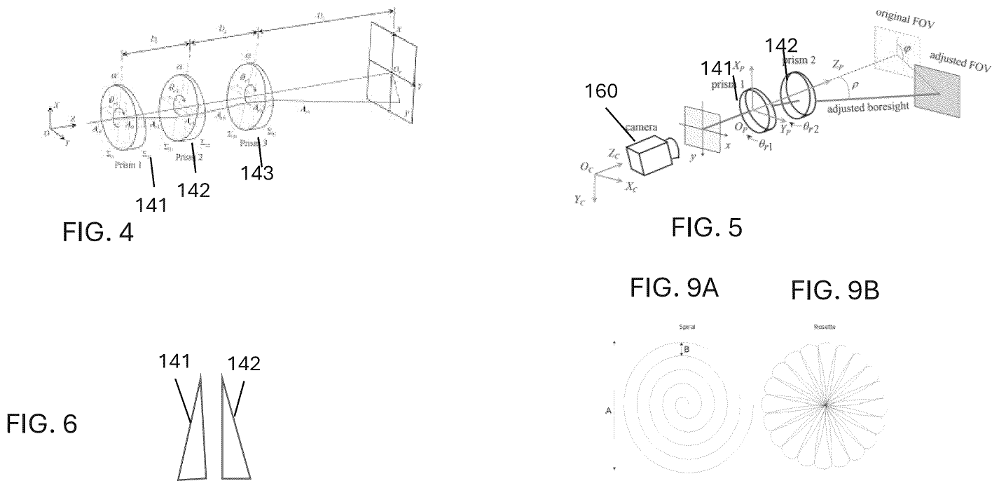

As illustrated in FIGS. 4 and 5, an actual configuration may include a plurality of wedge prisms 141, 142 143, e.g., two or three wedge prisms, to be rotated relative to one another. More wedge prisms allows an increased coverage over the field of view to be realized. A maximum displacement of a light beam, i.e., a maximum field of view, is created when the two prisms are aligned with the flat faces towards each other as shown in FIG. 6, which is typically set as a home position.

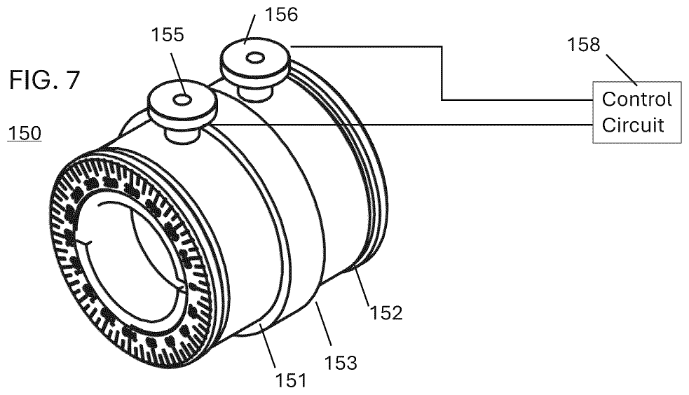

In addition, the wedge prisms 141, 142 may be scanned along the interior to adjust the viewing angle rotating the prisms, the entire field of view is shifted, allowing one to image different areas within a large field of regard, without sacrificing resolution. By individually rotating the wedge prisms 141, 142, different scan patterns may be realized. As shown in FIG. 7, to control the individual wedge prisms 141, 142, each wedge prism 141, 142 is mounted a housing 150 that includes individual mounts for 151 for the first wedge prism 141 and 152 for the second wedge prism 142 joined together, e.g., by a band 153, each having a rotation mechanism 155, 156 that are individually controlled by a control circuit 158 in accordance with a scan pattern to be realized via the control button 180 or based on a program transmitted to the control circuit 158 to automatically scan the wedge prisms. The control circuit 158 may be mounted on the heat shield 170 or may be separate therefrom, as long as it is in communication with the rotation mechanisms 155, 156.

Alternatively or additionally, the rotation mechanisms 155, 156 may be manually adjusted either by using the control button 180 to instruct the control circuit 158 or a mechanical relay shaft 220 shown in FIG. 8A to 8C. As shown in FIGS. 8A to 8C, the metal tube 190 may include a plurality of relay sections 192, 192b, 192c, here three, to relay the image from the pair of wedge prisms 140 to the camera 160 and a section 194 housing the pair of wedge prisms 140 and lenses 132, 134. Pairs of connectors 196 securing these sections together may include opening or holes 196h therein to guide the mechanical relay shaft 220 to the end of the metal tube 190. A gear 210 surrounds the pair of wedge prisms 140 and, together with a cam gear 225 on the end of the mechanical relay shaft 220 that interlocks with the gear 210, rotate the pair of wedge prisms 140 in response to a user rotating the mechanical relay shaft 220. The mechanical relay shaft 220 extends beyond the heat shield 170 to be controlled by a user.

Further alternatively, the first and second wedge prisms 141, 142 may be in positions fixed to one another, and are rotatable together to create a circular scanning pattern either by automatically by the control circuit 158 or manually, either by using the control button 180 to instruct the control circuit 158 or the mechanical relay shaft 220. While FIGS. 8A to 8C illustrate a configuration in which the wedge prisms 141, 142 are fixed together to rotate together and FIG. 7 illustrates a configuration in which the wedge prisms 141, 142, are separately rotated, either configuration may be used with either the control circuit 158 or the mechanical relay shaft 220. Further, both types of control may be used in the same camera inspection system 100.

A wide variety of scan patterns may be generated in accordance with relative speed and direction of rotation of the prisms 141, 142. Some examples of the scan pattern include a spiral shown in FIG. 8A and a Rosette shown in FIG. 8B. Numerous Rose curves, i.e., a full family of curves that repeat regularly, may be generated. Scanning area is dictated by wedge angle, prism thickness, and prism material, and depends on the wavelengths being imaged. When using only two wedge prisms, not all positions in the field of regard may be covered. By using three wedge prisms, any point in the field of regard may be imaged.

The present disclosure is not limited to only the above-described embodiments, which are merely exemplary. It will be appreciated by those skilled in the art that the disclosed systems and/or methods can be embodied in other specific forms without departing from the spirit of the disclosure or essential characteristics thereof. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. The presently disclosed embodiments are therefore considered to be illustrative and not restrictive. The disclosure is not exhaustive and should not be interpreted as limiting the claimed invention to the specific disclosed embodiments. In view of the present disclosure, one of skill in the art will understand that modifications and variations are possible in light of the above teachings or may be acquired from practicing of the disclosure. The scope of the invention is indicated by the appended claims, rather than the foregoing description.

1. An inspection system for inspecting an interior of high temperature process equipment, comprising:
an infrared camera;
a first wedge prism and second wedge prism to be inserted into a port of the high temperature process equipment to view the interior; and
an optical relay and relaying light output from the first and second wedge prisms to the infrared camera.

2. The inspection system according to claim 1, wherein the first and second wedge prisms are individually rotatable relative to one another.

3. The inspection system according to claim 2, further comprising:
a control circuit configured to control relative speed and direction of rotation of the first and second wedge prisms.

4. The inspection system according to claim 3, wherein the control circuit is configured to automatically control relative speed and direction of rotation of the first and second wedge prisms based on a predetermined scan pattern.

5. The inspection system according to claim 1, wherein the first and second wedge prisms are in positions fixed to one another and are rotatable together to create a circular scanning pattern.

6. The inspection system according to claim 5, further comprising:
a control circuit configured to control rotation of the first and second wedge prisms.

7. The inspection system according to claim 5, further comprising a gear surrounding the first and second wedge prisms to mechanically rotate the first and second wedge prisms together.

8. The inspection system according to claim 7, further comprising a shaft having a cam gear on a first end of the shaft, the cam gear to interlock with the gear and, in response to a user rotating the shaft, control the rotation of the first and second wedge prisms together.

9. The inspection system according to claim 1, further comprising, between the first and second wedge prisms and the optical relay:
a focus lens; and
a collimating lens.

10. The inspection system according to claim 1, further comprising a third wedge prism individually rotatable relative to the first and second wedge prisms.

11. The inspection system according to claim 1, wherein the first and second wedge prisms are final optical elements for capturing an image of the interior of high temperature process equipment.

12. The inspection system according to claim 1, wherein there is an optical protective window in front of the first and second wedge prisms.

13. The inspection system according to claim 1, further comprising a gear surrounding the pair of wedge prism to mechanically rotate the.

14. A method for inspecting an interior of high temperature process equipment, the method comprising:
providing a first wedge prism, a second wedge prism and an optical relay that relays light between the first and second wedge prisms and an infrared camera to view the interior; and
controlling rotation of the first wedge prism and the second wedge prism to scan the interior of the high temperature process equipment.

15. The method according to claim 14, wherein the first wedge prism and the second wedge prism are in fixed positions relative to one another.

16. The method according to claim 14, wherein controlling rotation includes individually controlling rotation of the first wedge prism and the second wedge prism.
